(19) United States
(12) Patent Application Publication
(10) Pub. No.: US 2025/0080784 A1
(43) Pub. Date: Mar. 6, 2025

(54) ESTIMATION METHOD, COMPUTER-READABLE RECORDING MEDIUM STORING ESTIMATION PROGRAM, AND COMMUNICATION PROCESSING DEVICE

(71) Applicant: Fujitsu Limited, Kawasaki-shi Kanagawa (JP)

(72) Inventors: Junki OURA, Kawasaki (JP); Akihiro WADA, Kawasaki (JP); Masatoshi OGAWA, Zama (JP); Kaoru YOKOO, Yokosuka (JP); Jun KAKUTA, Yokohama (JP); Teruhisa NINOMIYA, Yokohama (JP)

(73) Assignee: Fujitsu Limited, Kawasaki-shi Kanagawa (JP)

(21) Appl. No.: 18/804,186

(22) Filed: Aug. 14, 2024

(30) Foreign Application Priority Data
Sep. 6, 2023 (JP) 2023-144778

(51) Int. Cl. H04N 21/24; H04N 21/238; H04N 21/25

(52) U.S. Cl. CPC H04N 21/2402; H04N 21/238; H04N 21/251

(57) ABSTRACT

A method to estimate, in a communication system that includes a first communication device that executes a service, a second communication device that communicates with the first communication device via a network, and a monitoring device that monitors the network, quality of the service executed by the first communication device, includes obtaining a packet transmitted in a predetermined direction over the network, classifying the obtained packet into a packet of a first type and a packet of a second type different from the packet of the first type, and determining a feature for each type of the classified packet, and estimating the quality of the service executed by the first communication device by using a training model trained by using the feature and the quality of the service at timing when the packet used to determine the feature is transmitted, by processor circuitry.

### CROSS-REFERENCE TO RELATED APPLICATION

This application is based upon and claims the benefit of priority of the prior Japanese Patent Application No. 2023-144778, filed on Sep. 6, 2023, the entire contents of which are incorporated herein by reference.

### FIELD

The embodiments discussed herein are related to an estimation method, an estimation program, and a communication processing device.

### BACKGROUND

In recent years, with the advent of various applications, demands for a network change on a daily basis. In order to effectively use limited network resources in a communication system, the resources need to be appropriately allocated according to importance and characteristics of the applications.

For example, in a certain communication system, a system administrator may monitor a communication state and the like of the network to dynamically perform control. However, in many cases, it is more difficult to manually monitor and control the network as the configuration of the communication system becomes more complex.

In view of the above, the control of the network may be automated to avoid overlooking of a problem caused by human monitoring and to execute immediate control. In an automated control system, for example, features (e.g., number of packets that have passed within a predetermined time, data capacity, etc.) are extracted from packets flowing through a network, and quality is estimated using a machine learning model created in advance.

Techniques of controlling resources of a network are disclosed in, for example, the following documents.

Japanese Laid-open Patent Publication No. 2012-191372, Japanese Laid-open Patent Publication No. 2011-172150, and U.S. Patent Application Publication No. 2020/0244490 are disclosed as related art.

### SUMMARY

According to an aspect of the embodiments, a method to estimate, in a communication system that includes a first communication device that executes a service, a second communication device that communicates with the first communication device via a network, and a monitoring device that monitors the network, quality of the service executed by the first communication device, the method includes obtaining a packet transmitted in a predetermined direction over the network, classifying the obtained packet into a packet of a first type and a packet of a second type different from the packet of the first type, and determining a feature for each type of the classified packet, and estimating the quality of the service executed by the first communication device by using a training model trained by using the feature and the quality of the service at timing when the packet used to determine the feature is transmitted, by a processor.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating an exemplary configuration of a communication system 10;

FIG. 2 is a diagram illustrating an exemplary configuration of a monitoring device 100;

FIG. 3 is a diagram illustrating an exemplary software configuration of the monitoring device 100;

FIG. 4 is a diagram illustrating an exemplary model training process in the monitoring device 100;

FIG. 5 is a diagram illustrating an exemplary feature of uplink packets;

FIG. 6 is a diagram illustrating an exemplary processing flowchart of a training data generation process S100;

FIG. 7 is a diagram illustrating an exemplary processing flowchart of a ground truth data generation process S200;

FIG. 8 is a diagram illustrating an exemplary processing flowchart of a service quality estimation model training process S300;

FIG. 9 is a diagram illustrating an exemplary service quality estimation process in the monitoring device 100; and

FIG. 10 is a diagram illustrating an exemplary processing flowchart of a service quality estimation process S400.

### DESCRIPTION OF EMBODIMENTS

Packet monitoring needs to keep capturing a large number of packets to extract features. Furthermore, as the number of target packets increases, the processing load of packet capturing processing and feature extraction processing increases, and the network control may not be performed in real time.

Hereinafter, embodiments of techniques capable of reducing a processing load in network monitoring will be described.

### First Embodiment

A first embodiment will be described.

### [Communication System 10]

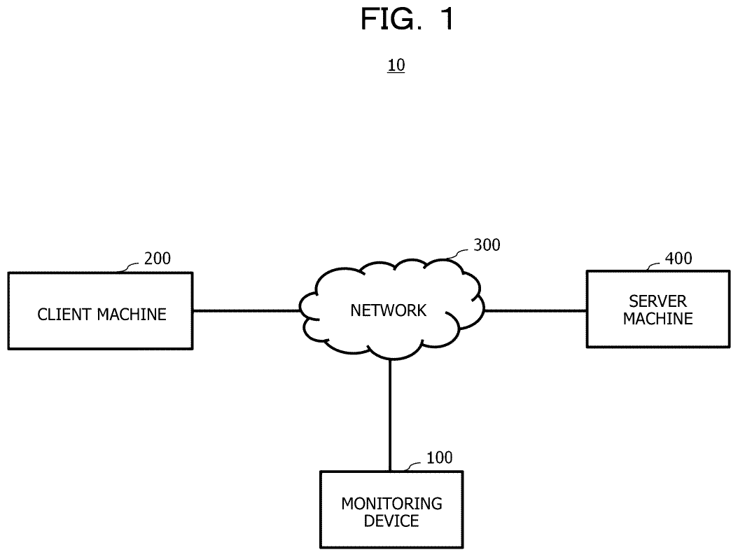

FIG. 1 is a diagram illustrating an exemplary configuration of a communication system 10. The communication system 10 includes a monitoring device 100, a client machine 200, a server machine 400, and a network 300. The communication system 10 is a client server system in which the server machine 400 transmits corresponding data to the client machine 200 in response to a request of a service executed by the client machine 200. Examples of the executed service include a video distribution application. Note that the service may be referred to as, for example, an application.

The client machine 200 is a communication device that executes a service and receives data from the server machine 400, and is, for example, a tablet terminal device, a smartphone, or a computer. In execution of the video distribution application, for example, the client machine 200 transmits a request message of video data to the server machine 400, receives the video data from the server machine 400, and transmits an acknowledgment message (ACK) indicating that the video data has been successfully received in a normal manner to the server machine 400. Furthermore, when the client machine 200 has failed to normally receive the video data, it transmits a non-acknowledgment message (NACK) indicating that the video data has not been successfully received in a normal manner to the server machine 400.

The server machine 400 is a communication device that responds to a request from the client machine 200 and transmits data to the client machine 200, and is, for example, a computer or a server machine. In the execution of the video distribution application by the client machine 200, the server machine 400 receives the request message of the video data from the client machine 200, and transmits one or a plurality of packets containing the video data corresponding to the request to the client machine 200. Furthermore, upon reception of the ACK, the server machine 400 transmits, for example, subsequent video data to the client machine 200. Furthermore, upon reception of the NACK, the server machine 400 retransmits the video data contained in the packet corresponding to the NACK to the client machine 200.

The network 300 is a network that couples the client machine 200, the server machine 400, and the monitoring device 100, and is, for example, the Internet or an infrastructure network. The network 300 is capable of exchanging packets between communication devices. A packet may contain data and messages. For example, the network 300 performs communication in accordance with a communication protocol such as the hypertext transfer protocol (HTTP), the hypertext transfer protocol secure (HTTPS), or the like.

The monitoring device 100 is a communication processing device that obtains packets exchanged between the client machine 200 and the server machine 400 in the network 300 and monitors the network, and is, for example, a computer or a server machine. The monitoring device 100 captures, for example, a packet transmitted in the uplink direction (direction from the client machine 200 toward the server machine 400) on the network 300, and monitors a state of the network. Furthermore, the monitoring device 100 estimates quality of a service being executed (which may be referred to as service quality hereinafter) from the state of the network. Examples of the service quality include a mean opinion score (MOS). The MOS is, for example, a value obtained in such a manner that evaluators view distributed video whose image quality changes depending on the state of the network to make an evaluation in five levels of 1 (bad) to 5 (good), and the evaluation results are averaged by the number of the evaluators, and is an evaluation value including human subjectivity. Note that the service quality to be used is not limited to the MOS.

### [Exemplary Configuration of Monitoring Device 100]

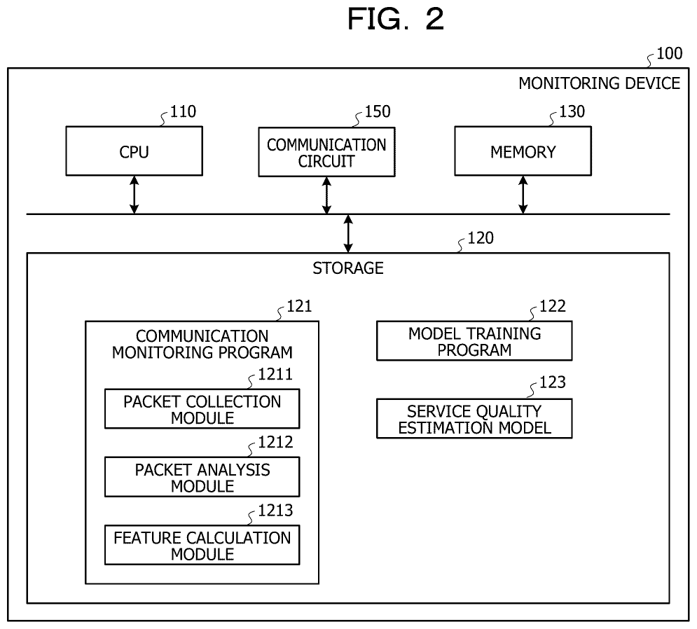

FIG. 2 is a diagram illustrating an exemplary configuration of the monitoring device 100. The monitoring device 100 includes a central processing unit (CPU) 110, storage 120, a memory 130, and a communication circuit 150.

The storage 120 is an auxiliary storage device that stores programs and data, such as a flash memory, a hard disk drive (HDD), a solid state drive (SSD), or the like. The storage 120 stores a communication monitoring program 121, a model training program 122, and a service quality estimation model 123.

The service quality estimation model 123 is a training model of artificial intelligence (AI) that estimates service quality in the client machine 200. For example, the service quality estimation model 123 is a training model trained by using, as input data, a feature regarding a packet, corresponding service quality, and the like. Note that, although there is one service quality estimation model 123 in FIG. 2, there is a plurality of service quality estimation models 123 for each type of application in a case of supporting a plurality of types of applications.

The memory 130 is an area into which a program stored in the storage 120 is loaded. Furthermore, the memory 130 may be used as an area in which the program stores data.

The communication circuit 150 is a device that exchanges packets with another communication device and performs communication, and is, for example, a network interface circuit. The communication circuit 150 communicates with the client machine 200 and the server machine 400, and obtains packets exchanged through the network 300.

The CPU 110 is a processor that constructs each unit and implements each type of processing by loading a program stored in the storage 120 into the memory 130 and executing the loaded program.

The CPU 110 executes the communication monitoring program 121 to construct a packet collection unit, a packet acquisition unit, and a packet type identification unit, and performs a communication monitoring process. The communication monitoring process is a process of obtaining packets exchanged through the network 300 and monitoring the state of the network 300. The communication monitoring process includes processing of obtaining (capturing) packets exchanged through the network 300, processing of analyzing and classifying contents and types of the obtained packets, processing of calculating a feature of the classified packets, and the like.

The CPU 110 executes a packet collection module 1211 included in the communication monitoring program 121 to construct a packet collection unit and an acquisition unit, and performs a packet collection process. The packet collection process is a process of obtaining packets between the client machine 200 and the server machine 400 exchanged through the network 300. The packet collection process obtains, for example, packets in the uplink direction.

The CPU 110 executes a packet analysis module 1212 included in the communication monitoring program 121 to construct a classification unit, an application estimation unit, and a packet type identification unit, and performs a packet analysis process. The packet analysis process is a process of analyzing the contents and types of the obtained packets and classifying the packets. For example, the monitoring device 100 classifies the packets into the ACK and the others. Furthermore, the packet analysis process includes, for example, processing of specifying (estimating) a type and a name of an application with which the obtained packets are exchanged.

The CPU 110 executes a feature calculation module 1213 included in the communication monitoring program 121 to construct a feature calculation unit (feature determination unit), and performs a feature calculation process. The feature calculation process is a process of calculating (extracting) a feature, such as the number of packets or a data amount in a predetermined time, or the like, for each classified packet (or packet group).

The CPU 110 executes the model training program 122 to construct a model training unit, and performs a model training process. The model training process is a process of training the service quality estimation model 123 to be described later. The monitoring device 100 performs the model training process by inputting ground truth data and training data to the service quality estimation model 123.

### [Exemplary Software Configuration of Monitoring Device 100]

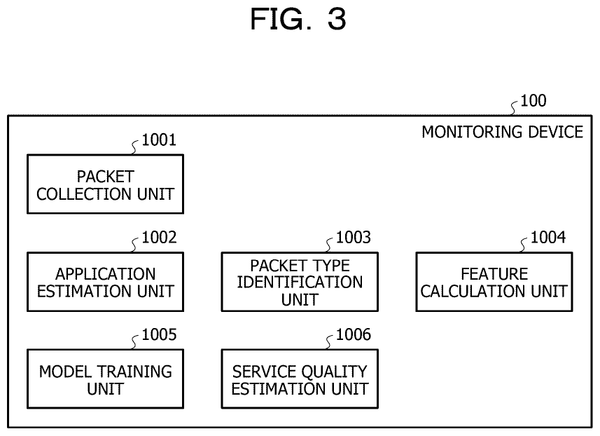

FIG. 3 is a diagram illustrating an exemplary software configuration of the monitoring device 100. The monitoring device 100 executes a program to construct a packet collection unit 1001, an application estimation unit 1002, a packet type identification unit 1003, a feature calculation unit 1004, a model training unit 1005, and a service quality estimation unit 1006.

The packet collection unit 1001 performs the packet collection process of obtaining packets (packet group) between the client machine 200 and the server machine 400 exchanged through the network 300.

The application estimation unit 1002 analyzes a type and contents of the obtained packets to estimate (classify) a type of the application running in the client machine 200.

The packet type identification unit 1003 analyzes a type and contents of each packet of the obtained packet group, and performs the packet analysis process of classifying the packets. For example, the packet type identification unit 1003 classifies the packets into the ACK and the others.

The feature calculation unit 1004 performs, for each classified packet, the feature calculation process of calculating a feature regarding the number of packets, a data amount, and the like in a predetermined time.

The model training unit 1005 performs the model training process of inputting ground truth data and training data to the service quality estimation model 123 and carries out training.

The service quality estimation unit 1006 performs the service quality estimation process of estimating service quality using the features of the packets. Note that examples of the service quality estimation unit 1006 include the service quality estimation model 123.

[Model Training Process]

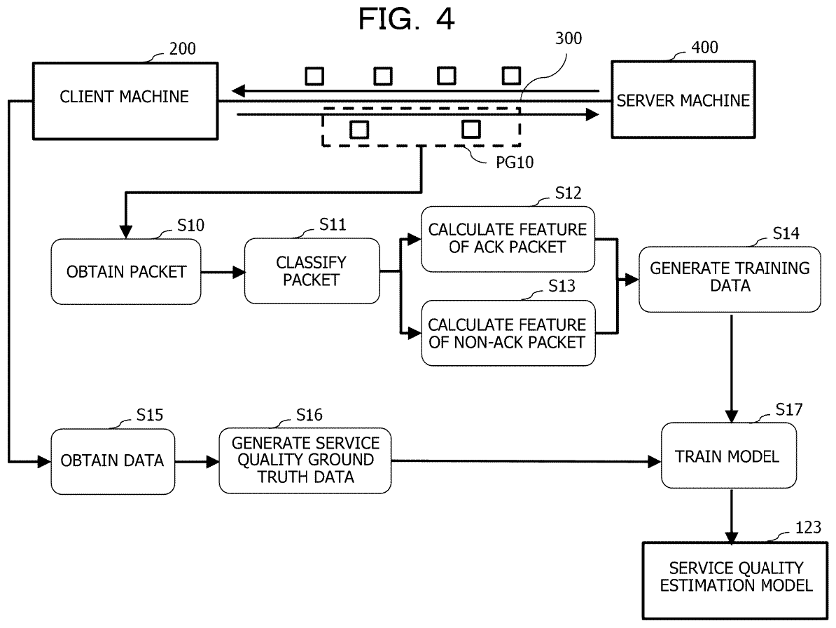

The model training process of the service quality estimation model 123 will be described. FIG. 4 is a diagram illustrating an example of the model training process in the monitoring device 100.

In FIG. 4, the client machine 200 executes, for example, a video distribution application. The video distribution application is an application that requests the server machine 400 to transmit video, receives a packet containing divided video data from the server machine 400, and reproduces it on a screen of the client machine 200. In the network 300, for example, a request packet including a request for video data, an ACK packet including an ACK indicating that video has been successfully received, and a NACK packet indicating that video has not been successfully received, and the like flow in the uplink direction. Furthermore, in the network 300, for example, a data packet including video data flows in the downlink direction.

The monitoring device 100 obtains packets (S10). The packet acquisition is processing of obtaining a packet group PG10 transmitted from the network 300 in the uplink direction in a predetermined time.

The monitoring device 100 performs packet classification (S11). The packet classification includes processing of flow division of the obtained packets. Hereinafter, the monitoring device 100 is assumed to execute, for each of the divided flows, model training, application estimation, feature calculation, service quality estimation, and the like.

Furthermore, in the packet classification, application estimation is performed in which a type of the application being executed by the client machine 200 is estimated from the type and contents of the obtained packets. Note that, since an application may be executed to perform model training in the model training process, the type of the application may be obvious without performing the estimation. In this case, the estimation processing may not be performed.

An application estimation method may use, for example, a packet destination, a transmission source address, a port number, and the like. For example, when there is a characteristic traffic pattern of a specific service, a correspondence relationship between the characteristic and the service (application type) may be prepared in advance, and the application estimation may be performed using the correspondence relationship. For example, in the video distribution application, the characteristic traffic pattern may be that a large-capacity file is intermittently transmitted from the server machine 400 to the client machine 200. Accordingly, the monitoring device 100 may estimate that the application is a video distribution application by analyzing a size of data included in the packets, the number of packets within a predetermined time, packet transmission intervals, and the like. Hereinafter, the monitoring device 100 is assumed to execute, for each estimated application type, feature determination, the service quality estimation process, and the like. Furthermore, in the packet classification, a type and contents of each packet of the obtained packets are analyzed to classify the packets. The packets are classified into, for example, an ACK packet or another packet (which will be referred to as a non-ACK packet).

The monitoring device 100 calculates a feature for each classified packet. For example, the monitoring device 100 calculates a feature of the ACK packet (S12), and calculates a feature of the non-ACK packet (S13).

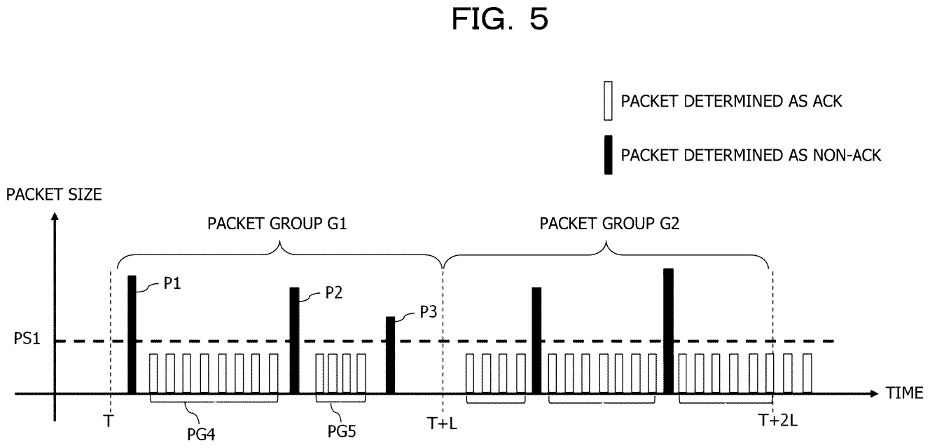

FIG. 5 is a diagram illustrating an exemplary feature of uplink packets. FIG. 5 illustrates exemplary packets in execution of the video distribution application. When no error occurs in data transmission, packets transmitted as the uplink packets include a request packet (non-ACK packet) and an ACK packet.

The monitoring device 100 obtains a packet group G1 for a predetermined time L from acquisition start time T. For example, the monitoring device 100 periodically (every predetermined time L) obtains packets (packet group).

The monitoring device 100 classifies each packet of the packet group G1 into an ACK packet or a non-ACK packet depending on, for example, a packet size. The monitoring device 100 classifies a packet having a packet size of equal to or smaller than PS as an ACK packet, and classifies the others as non-ACK packets. This classification method uses the fact that the packet size of the ACK packet is relatively small as compared with other packets (e.g., request packet) and that the packet size of the ACK packet is roughly determined. The size of the ACK packet may be obtained by, for example, calculating an appearance frequency of a packet size in a measured section (time) and calculating the average size of the packets having the highest appearance frequency. Note that the packet classification may be carried out according to information of a header portion of a packet (packet type) or the like. In FIG. 5, the classification is made into ACK packet groups PG4 and PG5 and non-ACK packets P1 to P3.

The feature is determined (calculated) from, for example, the packet transmission intervals, the total number of packets, the total packet capacity, the packet throughput, and a value obtained by statistically processing those items in a predetermined period. The feature to be used for the training (used as training data) may be one type, or a plurality of types of features may be used. The statistical processing includes, for example, an average, a maximum value, a minimum value, a mode value, a median value, variance, kurtosis, and skewness.

Furthermore, the feature may include, for example, a relation value between the ACK packet and the non-ACK packet (e.g., ratio between the ACK packet and the non-ACK packet, comparison value of the total value of the data amount, etc.) in addition to a numerical value calculated for each ACK packet and non-ACK packet.

For example, in the case of the video distribution application, when a communication state is favorable and there is no error, a plurality of (e.g., predetermined number of) downlink video packets is received in response to one uplink request packet, and a plurality of (e.g., predetermined number of) uplink ACK packets is transmitted in response to those video packets. For example, when the video application is favorably operated, it may be assumed that a state in which a predetermined number of ACK packets are transmitted for one non-ACK packet in the uplink packets occurs periodically and continuously for a certain period. As described above, the monitoring device 100 may estimate the application running state (packet state in the network) from the feature of the uplink packets. Note that the service quality estimation model 123 may further estimate the service quality by inputting the corresponding service quality as ground truth data and carries out training in addition to the feature of the packets.

Furthermore, the feature to be determined may be, for example, only the ACK packet or only the non-ACK packet. The monitoring device 100 may determine the feature of only the ACK packet or the non-ACK packet having characteristics (packet whose characteristics are more noticeable).

Returning to FIG. 4, the monitoring device 100 generates training data from the feature of the ACK packet and the feature of the non-ACK packet (S14). The training data is data to be used for the model training.

Meanwhile, the monitoring device 100 obtains data from the client machine 200 (S15). The data is data to be used to generate ground truth data to be used for the model training. For example, in the case of using the MOS as the service quality, the data to be obtained is, for example, user ratings (e.g., ratings in five levels of 1 (bad) to 5 (good)) of the client machine 200. Furthermore, in the case of using the MOS as the service quality, for example, the data to be obtained is, for example, image information (e.g., image resolution, bit rate, display resolution of the client machine 200, etc.) related to an image.

The monitoring device 100 generates ground truth data including the service quality at the timing (period) when the feature is calculated from the obtained data (S16). For example, when the obtained data is user ratings, the monitoring device 100 sets the average value of the ratings in the period in which the feature is calculated as the ground truth data. Furthermore, for example, when the obtained data is image information, the monitoring device 100 calculates an approximate value of the MOS using the calculation formula of “ITU-T P.1203” using the image information of the period in which the feature is calculated, and sets the calculated approximate value as the ground truth data. The “ITU-T P.1203” is a standard that has been standardized, and defines a calculation formula for calculating an approximate value of the MOS from image information as a function of estimating audio and video quality in a short time.

The monitoring device 100 carries out the model training using the ground truth data and the training data (S17), and generates the trained service quality estimation model 123.

### [Processing Flowchart of Model Training Process]

Detailed processing of the model training process will be described. Here, each process will be described including a training data generation process S100 up to the generation of the training data, a ground truth data generation process S200 up to the generation of the ground truth data, and a service quality estimation model training process S300 up to the generation (training) of the service quality estimation model 123.

### [1. Training Data Generation Process S100]

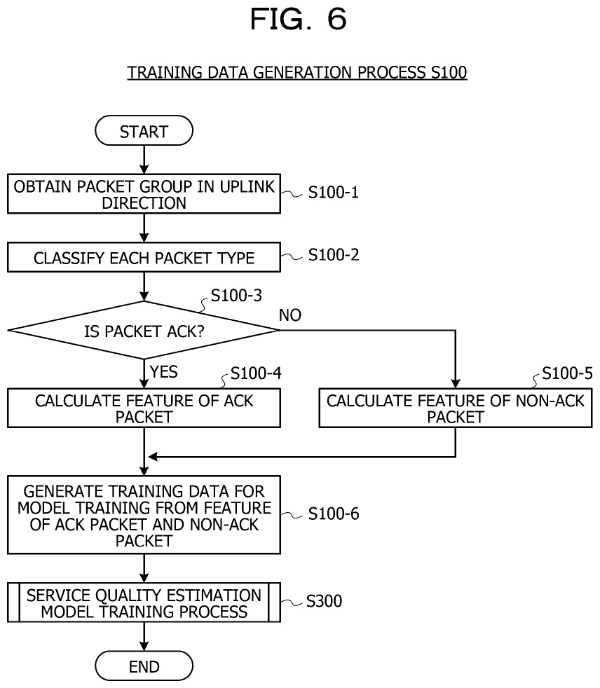

FIG. 6 is a diagram illustrating an exemplary processing flowchart of the training data generation process S100. The monitoring device 100 obtains a packet group in the uplink direction (S100-1). For example, the monitoring device 100 periodically obtains a packet group. Hereinafter, it is assumed that the training data generation process is performed for each packet flow and each application.

The monitoring device 100 classifies a packet type for each packet included in the packet group (S100-2). In the processing S100-2, for example, packets are classified into an ACK packet and a non-ACK packet depending on a size of the packet.

The monitoring device 100 calculates, using the ACK packet (Yes in S100-3), a feature of the ACK packet (S100-4). On the other hand, the monitoring device 100 calculates, using the non-ACK packet (No in S100-3), a feature of the non-ACK packet (S100-5).

The monitoring device 100 generates training data for model training from the features of the ACK packet and the non-ACK packet (S100-6). The monitoring device 100 executes the service quality estimation model training process S300 using the training data, and terminates the process.

### [2. Ground Truth Data Generation Process S200]

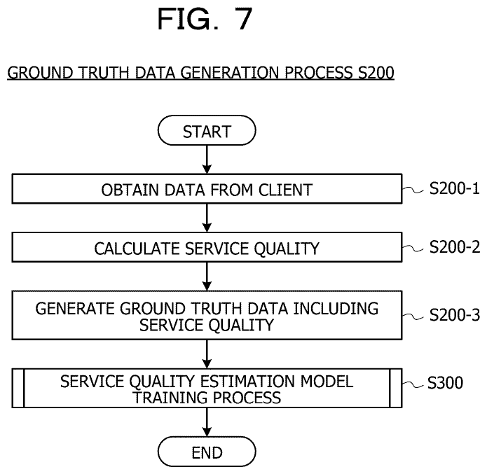

FIG. 7 is a diagram illustrating an exemplary processing flowchart of the ground truth data generation process S200. The monitoring device 100 obtains data from the client machine 200 (S200-1). The data is, for example, data to be used to calculate the MOS or an approximate value of the MOS. Furthermore, the data acquisition may be carried out in response to, for example, the acquisition of the packet group in the training data generation process S100.

The monitoring device 100 determines service quality from the obtained data (S200-2).

The monitoring device 100 generates ground truth data including the determined service quality (S200-3).

The monitoring device 100 executes the service quality estimation model training process S300 using the ground truth data, and terminates the process.

### [3. Service Quality Estimation Model Training Process S300]

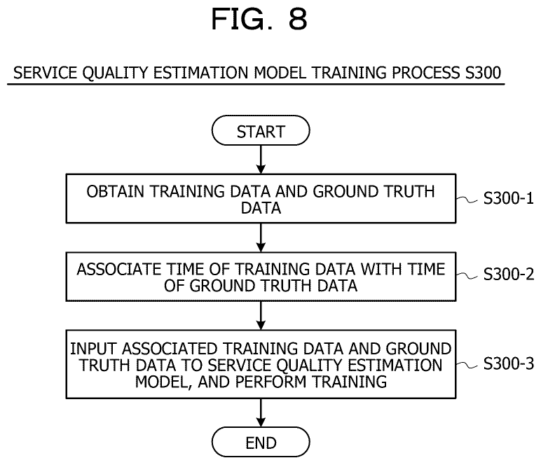

FIG. 8 is a diagram illustrating an exemplary processing flowchart of the service quality estimation model training process S300. The monitoring device 100 obtains training data and ground truth data (S300-1).

The monitoring device 100 associates the time of the training data with the time of the ground truth data (S300-2). The monitoring device 100 associates the time at which the packet for which the feature of the training data is calculated is transmitted or obtained with the time at which the data used to generate the ground truth data is obtained or generated. For example, the monitoring device 100 associates the timing at which the packet used to generate the training data flows on the network 300 with the quality of the service executed in the client machine 200, and uses it for training.

The monitoring device 100 inputs the associated training data and ground truth data to the service quality estimation model 123, carries out training (S300-3), and terminates the process. As an algorithm used for the training, for example, a random forest, a multilayer perceptron, a long short-term memory, a transformer, or the like is used. According to the processing S300-3, the service quality estimation model 123 becomes a trained model.

### [Service Quality Estimation Process]

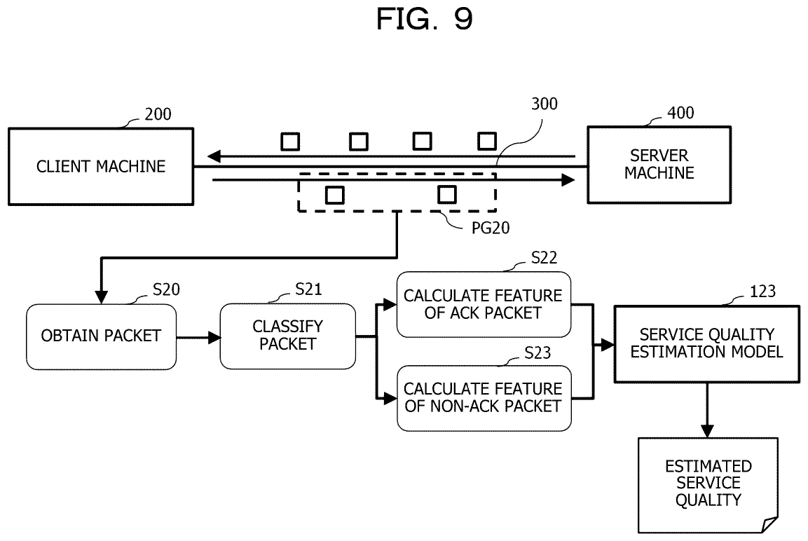

The service quality estimation process using the trained service quality estimation model 123 will be described. FIG. 9 is a diagram illustrating an example of the service quality estimation process in the monitoring device 100.

In FIG. 9, the client machine 200 executes the video distribution application. The video distribution application is an application that requests the server machine 400 to transmit video, receives a packet containing divided video data from the server machine 400, and reproduces it on a screen of the client machine 200. In the network 300, for example, a request packet including a request for video data, an ACK packet including an ACK indicating that video has been successfully received, and a NACK packet indicating that video has not been successfully received, and the like flow in the uplink direction. Furthermore, in the network 300, for example, a data packet including video data flows in the downlink direction.

The monitoring device 100 obtains packets (S20). The packet acquisition is processing of obtaining a packet group PG20 transmitted from the network 300 in the uplink direction in a predetermined time.

The monitoring device 100 performs packet classification (S21). The packet classification includes processing of flow division of the obtained packets. Furthermore, the packet classification estimates a running application. Here, the running application is estimated as a video distribution application.

The monitoring device 100 calculates a feature for each classified packet. For example, the monitoring device 100 calculates a feature of the ACK packet (S22), and calculates a feature of the non-ACK packet (S23). The feature to be calculated is assumed to include all or a part of the feature used to generate the training data.

The monitoring device 100 inputs the feature of the ACK packet and the feature of the non-ACK packet to the service quality estimation model 123, and causes it to output estimated service quality. The service quality estimation model 123 to be used is a model that has been trained and further supports the running application. Furthermore, the estimated service quality to be output is service quality used to generate the ground truth data, and is, for example, the MOS (including approximate value).

### [Processing Flowchart of Service Quality Estimation Process]

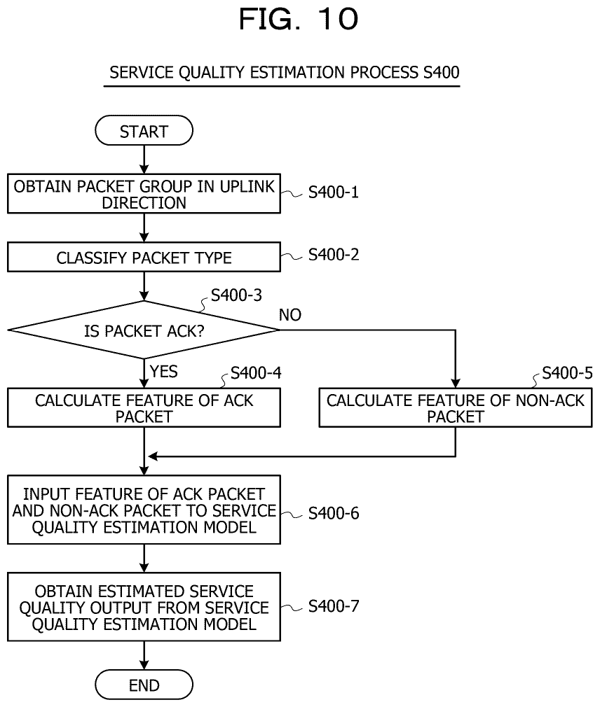

Detailed processing of the service quality estimation process will be described. FIG. 10 is a diagram illustrating an exemplary processing flowchart of the service quality estimation process S400.

The monitoring device 100 obtains a packet group in the uplink direction (S400-1). For example, the monitoring device 100 periodically obtains a packet group.

The monitoring device 100 classifies a packet type for each packet included in the packet group (S400-2). In the processing S400-2, for example, packets are classified into an ACK packet and a non-ACK packet depending on a size of the packet.

The monitoring device 100 calculates, using the ACK packet (Yes in S400-3), a feature of the ACK packet (S400-4). On the other hand, the monitoring device 100 calculates, using the non-ACK packet (No in S400-3), a feature of the non-ACK packet (S400-5).

The monitoring device 100 inputs the features of the ACK packet and the non-ACK packet to the service quality estimation model 123 (S400-6).

The monitoring device 100 obtains the estimated service quality output from the service quality estimation model 123 (S400-7), and terminates the process.

### Second Embodiment

In the first embodiment, the case has been described in which, for example, the MOS is used as service quality. In a second embodiment, for example, a key quality indicator (KQI) is used as service quality. Note that the service quality to be used is not limited to the KQI.

The KQI includes, for example, a bit rate, resolution, a stall time, and the like of a video segment. For example, a client machine 200 periodically obtains the bit rate and the resolution to transmit them to a monitoring device 100. Furthermore, the monitoring device 100 may periodically obtain the bit rate from the client machine 200.

Furthermore, when the KQI is the stall time, the client machine 200 may measure a time during which video is stopped, store the time as a stall time, and transmit the stall time to the monitoring device 100 in response to a request from the monitoring device 100 or periodically, for example.

When the KQI is used as the service quality, for example, the processing S15 in FIG. 4 or the processing S200-1 in FIG. 7 is, for example, a stall time, resolution, a bit rate, or the like, and ground truth data is generated using the data.

### Third Embodiment

While uplink packets are obtained in the first embodiment as the video distribution application is running for example, downlink packets are obtained in a third embodiment. Alternatively, in the third embodiment, a direction of packet acquisition is switched between the uplink and the downlink for each service type.

For example, a monitoring device 100 may execute a service in advance to obtain uplink and downlink packets, and may set a direction in which the number of packets is smaller as a target direction of the packet acquisition.

For example, since the number of packets in the downlink is smaller than that in the uplink in a service of transmitting video captured by a client machine 200 to a server machine 400 or the like, the monitoring device 100 may obtain downlink packets at a time of executing this type of service.

### Fourth Embodiment

In the first embodiment, for example, the monitoring device 100 classifies the obtained packets into the ACK packet and the non-ACK packet. In a fourth embodiment, for example, a monitoring device 100 may further extract a request packet from non-ACK packets. Examples of the request packet include an HTTP request in the HTTP or the HTTPS. It is assumed that the monitoring device 100 checks a packet header and handles the HTTP request as a request packet.

### OTHER EMBODIMENTS

Each of the respective embodiments may be used in combination. Furthermore, the service quality and the feature are examples, and may be other than those described above.

Note that the feature of the ACK packet may be assumed to correlate with, for example, the bit rate of the video being reproduced. For example, it may be assumed that the packet interval is closer to a constant state as a standard deviation of the packet transmission interval is lower, which leads to a stable network, and it is highly likely that high-bit-rate video is being reproduced, whereby the service quality may be assumed to be high.

Furthermore, it may be assumed that a stable distribution with smaller variation is obtained as the kurtosis of the packet transmission interval becomes higher, which leads to a stable network, and it is highly likely that high-bit-rate video is being reproduced, whereby the service quality may be assumed to be high.

Furthermore, it may be assumed that, since a distribution of the packet intervals is biased in the left (0) direction as a value of the skewness of the packet transmission interval is larger, the packet intervals tend to be smaller and the packets are exchanged at a high speed, which leads to a stable network, and it is highly likely that high-bit-rate video is being reproduced, whereby the service quality may be assumed to be high.

As described above, the monitoring device 100 may assume various states to determine the feature.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A method to estimate, in a communication system that includes a first communication device that executes a service, a second communication device that communicates with the first communication device via a network, and a monitoring device that monitors the network, quality of the service executed by the first communication device, the method comprising:
obtaining a packet transmitted in a predetermined direction over the network;
classifying the obtained packet into a packet of a first type and a packet of a second type different from the packet of the first type, and determining a feature for each type of the classified packet; and
estimating the quality of the service executed by the first communication device by using a training model trained by using the feature and the quality of the service at timing when the packet used to determine the feature is transmitted, by processor circuitry.

2. The method according to claim 1, wherein the packet of the first type includes a packet that includes an acknowledgment that indicates normal data reception.

3. The method according to claim 2,
wherein the service includes a video distribution application, and
wherein the predetermined direction includes a direction from the first communication device toward the second communication device.

4. The method according to claim 3, wherein the processor circuitry classifies packets of the second type into a request packet for requesting from the first communication device to the second communication device, and another packet, and determines the feature of the request packet.

5. The method according to claim 1, wherein the predetermined direction includes a direction in which a number of packets transmitted within a predetermined time based on the execution of the service is smaller than the number of the packets in another direction.

6. The method according to claim 1, further comprising:
training the training model by using the determined feature and the quality of the service obtained from the first communication device.

7. The method according to claim 6,
wherein the quality of the service includes a mean opinion score (MOS), and
wherein the processor circuitry obtains, from the first communication device, image information regarding a reproduced image, and an approximate value of the MOS by using the image information, and regards the approximate value as the quality of the service.

8. The method according to claim 6,
wherein the quality of the service includes a key quality indicator (KQI), and
wherein the processor circuitry obtains, from the first communication device, image information regarding a reproduced image, and regards the image information as the quality of the service.

9. A non-transitory computer-readable recording medium storing an estimating program for causing a computer included in a monitoring device that monitors a network, the monitoring device being included in a communication system that includes a first communication device that executes a service, and a second communication device that communicates with the first communication device via the network, the computer executing a process, the process comprising:
obtaining a packet transmitted in a predetermined direction over the network;
classifying the obtained packet into a packet of a first type and a packet of a second type different from the packet of the first type, and determining a feature for each type of the classified packet; and
estimating the quality of the service executed by the first communication device by using a training model trained by using the feature and the quality of the service at timing when the packet used to determine the feature is transmitted.

10. A communication processing device that monitors a network, the communication processing device being included in a communication system that includes a first communication device that executes a service, and a second communication device that communicates with the first communication device via the network, the communication processing device comprising:
a memory; and
processor circuitry coupled to the memory and configured to:
obtain a packet transmitted in a predetermined direction over the network;
classify the obtained packet into a packet of a first type and a packet of a second type different from the packet of the first type, and determine a feature for each type of the classified packet; and
estimate the quality of the service executed by the first communication device by using a training model trained by using the feature and the quality of the service at timing when the packet used to determine the feature is transmitted.
